(19) United States
(12) Patent Application Publication
(10) Pub. No.: US 2014/0076281 A1
(43) Pub. Date: Mar. 20, 2014

(54) Low-Pressure Circuit for a Fuel Injection System

(71) Applicant: Robert Bosch GmbH, Stuttgart (DE)

(72) Inventor: Martin Bernhaupt, Oberalm (AT)

(73) Assignee: Robert Bosch GmbH, Stuttgart (DE)

(21) Appl. No.: 14/028,094

(22) Filed: Sep. 16, 2013

(30) Foreign Application Priority Data
Sep. 17, 2012 (AT) A 1011/2012

(51) Int. Cl. F02M 41/16

(52) U.S. Cl. CPC F02M 41/16
USPC 123/456

(57) ABSTRACT

A low-pressure circuit for a fuel injection system, such as a common-rail injection system, includes a predelivery pump by means of which fuel can be drawn out of the fuel tank and supplied via a fuel line to a low-pressure region of a high-pressure pump. A metering unit for flow rate regulation is located in the low-pressure region, a zero-delivery line with a zero-delivery throttle branches off downstream of the metering unit, and an overflow line with an overflow valve branches off upstream of the metering unit. There is located in the zero-delivery line a shut-off element, which can be switched between an open position and a closed position, for the selective opening or blocking of the zero-delivery line.

This application claims priority under 35 U.S.C. §119 to patent application no. A 1011/2012, filed on Sep. 17, 2012 in Austria, the disclosure of which is incorporated herein by reference in its entirety.

### BACKGROUND

The disclosure relates to a low-pressure circuit for a fuel injection system, in particular a common-rail injection system of internal combustion engines, comprising a predelivery pump by means of which fuel can be drawn out of a fuel tank and supplied via a fuel line to a low-pressure region of a high-pressure pump, wherein a metering unit for flow rate regulation is arranged in the low-pressure region, a zero-delivery line with a zero-delivery throttle branches off downstream of the metering unit, and an overflow line with an overflow valve branches off upstream of the metering unit.

A low-pressure circuit for a fuel injection system of the above-stated type emerges for example from the laid-open specification DE 199 26 308 A1. The fuel injection system comprises a high-pressure pump and, connected upstream, a predelivery pump which delivers a fuel stream out of a fuel tank via a fuel line. The fuel is supplied to a metering unit which is connected upstream of the high-pressure pump for the purpose of flow rate regulation. The metering unit permits the use of a conventional, unregulated predelivery pump. In the high-pressure pump, the delivery stream is charged with high pressure and supplied to a common distributor rail. The return line ensures that excess fuel is not unnecessarily charged with high pressure but rather can flow back directly into the tank.

Furthermore, an overflow line with an overflow valve is provided, which overflow line branches off from the delivery path upstream of the metering unit. It is the task of the overflow valve to discharge the excess flow rate of the predelivery pump with respect to the respectively required high-pressure pump delivery flow rate.

Furthermore, it is proposed in the laid-open specification DE 199 26 308 A1 that a zero-delivery line branches off between the metering unit and the high-pressure pump, in which zero-delivery line there is arranged a zero-delivery throttle. The zero-delivery line issues into the fuel line at the suction side of the predelivery pump. The zero-delivery line is necessary because the metering unit is generally not leak-tight even in the fully closed state. During normal operation of the engine, therefore, the leakage flow from the metering unit is discharged into the return line via the zero-delivery line and the zero-delivery throttle. Without the zero-delivery throttle, it would be the case during normal operation of the engine, and when the metering unit is in the closed state, that the leakage flow would be delivered into the high-pressure circuit, which is undesirable.

From the arrangement of the zero-delivery line, however, the problem now arises that, in the case of very low engine speeds, that is to say in particular upon starting of the engine, and the associated low delivery rate of the predelivery pump, a major part of said delivery flow is conducted off directly via the zero-delivery throttle into the unpressurized return line again rather than being made available for the build-up of pressure in the high-pressure system. This can considerably hinder or even prevent the starting of the engine. There is thus a conflict of aims with regard to the realization of a zero-delivery characteristic on the one hand and the starting capability on the other hand.

Taking the above-cited prior art as a starting point, it is therefore the object of the present disclosure to specify a low-pressure circuit for a fuel injection system, by means of which the described conflict of aims can be alleviated.

### SUMMARY

To achieve said object, the disclosure provides, in the case of a low-pressure circuit of the type mentioned in the introduction, that there is arranged in the zero-delivery line a shut-off element, which can be switched between an open state and a closed state, for the selective opening or blocking of the zero-delivery line. This offers the possibility of shutting off the zero-delivery line for the starting process in order that no loss flows arise in the system here. When regular operation (above idle rotational speeds) commences, however, the zero-delivery line should be opened again in order to be able to realize the zero-delivery characteristic. The shut-off element is preferably arranged downstream of the zero-delivery throttle such that the shut-off element is situated in the unpressurized region of the low-pressure circuit.

The actuation of the shut-off element may be controlled in a variety of ways. For example, the shut-off element may be connected to the central engine controller, or sensors may be provided for detecting the rotational speed of the internal combustion engine, which sensors open the shut-off element when the end of the starting process is identified. A structurally particularly simple and fail-safe design is preferably attained by virtue of the fact that control means are provided for controlling the state of the shut-off element as a function of the position of a valve closing member of the overflow valve. In particular, the control means are designed to open the shut-off element when the overflow valve is opened. The overflow valve opens when a certain pressure has built up upstream of the metering unit after the starting of the engine. Thus, the position of the valve closing member of the overflow valve can be used as a control parameter for the opening of the zero-delivery line.

What is particularly advantageous in this connection is a direct mechanical coupling of the valve closing member of the overflow valve to the shut-off element. The embodiment is in this case preferably such that the shut-off element is in the form of a valve with a valve closing member whose movement is coupled to the movement of the valve closing member of the overflow valve, in particular in such a way that the shut-off element is opened when the overflow valve is opened.

If, in a manner corresponding to a further preferred refinement, the valve closing member of the overflow valve is spring-loaded in a closing direction, the overflow valve is first opened when a lower threshold pressure is exceeded, such that the opening of the shut-off element is also correspondingly delayed. A further delay preferably arises by virtue of the fact that the movement of the valve closing member of the shut-off element is coupled to the movement of the valve closing member of the overflow valve only after an idle stroke of the latter valve closing member has been passed through.

The overflow valve is advantageously in the form of a slide valve, the valve closing member of which is formed by a displaceable piston.

Within the context of the disclosure, the shut-off element may be in the form of a check valve or in the form of a slide valve.

To permit retrofitting of existing assemblies, it is advantageous for the shut-off element to be structurally combined with the overflow valve. This is achieved for example in that the zero-delivery line issues into a spring chamber of the overflow valve and in that the shut-off element is connected to the spring chamber. In this context, another advantageous refinement provides that the spring chamber can be connected via a slide valve seat to a piston chamber, wherein the piston chamber is connected to the fuel return line via a bore which extends through the spring chamber and which is formed in an insert part.

### BRIEF DESCRIPTION OF THE FIGURES

The disclosure will be explained in more detail below on the basis of exemplary embodiments schematically illustrated in the drawing, in which:

FIG. 1 shows a common-rail injection system having a low-pressure circuit according to the prior art,

FIG. 2 shows a common rail injection system having a low-pressure circuit according to the disclosure in a first embodiment,

FIG. 3 shows a detail view of the low-pressure circuit in a second embodiment,

FIG. 4 shows a detail view of the low-pressure circuit in a third embodiment,

FIG. 5 shows a common-rail injection system having a low-pressure circuit according to the disclosure in a fourth embodiment, and

FIG. 6 shows a detail view of the embodiment as per FIG. 5.

### DETAILED DESCRIPTION

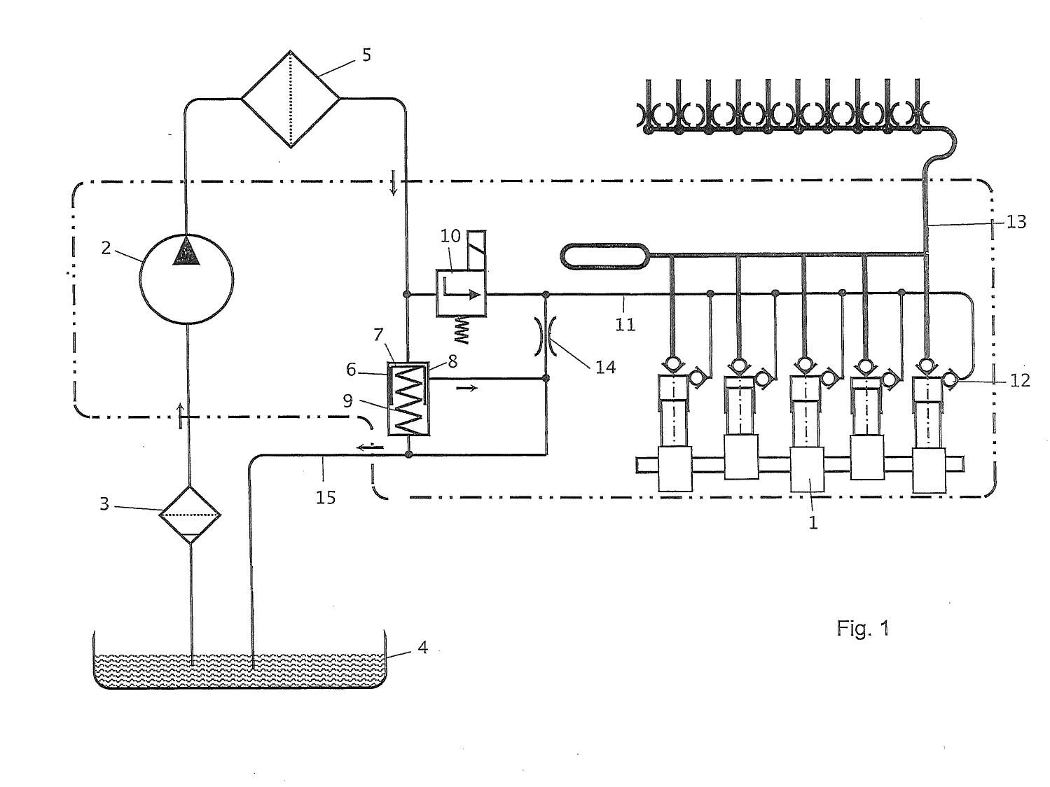

FIG. 1 illustrates a conventional embodiment of a low-pressure circuit of a common-rail injection system. In the standard design, the high-pressure pump 1 has fitted thereon a mechanical low-pressure predelivery pump 2 which is for example in the form of an external gear pump or internal gear pump and which is driven by the camshaft of the high-pressure pump and accordingly rotates at the same rotational speed. The predelivery pump 2 draws the fuel out of the tank 4 via a pre-filter 3 with integrated water separator, and delivers said fuel via the main filter 5 to the low-pressure region of the high-pressure pump 1. The delivery flow rate of the predelivery pump 2 is conventionally configured to be higher than the maximum delivery flow rate of the high-pressure pump 1 so as to ensure an adequate charging flow rate to the high-pressure pump in all operating states.

In the high-pressure pump 1 there is installed an overflow valve 6 which has the task of discharging the excess flow rate of the predelivery pump 2 with respect to the respectively required high-pressure pump delivery flow rate. Depending on said excess flow rate, an admission pressure is generated upstream of the high-pressure pump 1 in accordance with a pressure-flow rate characteristic curve of the overflow valve. The overflow valve is in the form of a slide valve, that is to say a discharge cross section 8 is opened up as a function of the stroke of the valve piston 7. In the case of low predelivery pressures, such as for example during the starting of the engine, the piston of the overpressure valve 6 is not deflected owing to the preload of the spring 9 of the overpressure valve 6, and it is thus also the case that there is no discharge flow. Here, a movement and thus an opening of the discharge cross section take place only above pressures of approximately 5 bar. In the high-pressure pump 1, the delivery flow rate of the high-pressure pump 1 is controlled by means of a metering unit 10. Said metering unit 10 is composed for example of a slide valve and a linear magnet. As a function of the actuation of the linear magnet, a certain throughflow cross section is opened up by means of the slide valve, and the delivery flow rate of the high-pressure pump 1 is thus set. Owing to the design as a slide valve, the metering unit 10 is not leak-tight even in the fully closed state, that is to say, in the presence of a predelivery pressure, there is a leakage flow into the high-pressure pump 1 via the slide gap. Since said leakage would inevitably cause a pressure build-up in the suction chamber 11 of the high-pressure pump 1 and thus lead to the opening of the suction valves 12 and to the delivery of said leakage into the high-pressure circuit 13, a so-called zero-delivery throttle 14 is necessary in order to realize a delivery flow rate of zero. Through the zero-delivery throttle 14, said leakage flow is conducted off back into the unpressurized return line 15, and thus a pressure increase in the suction chamber 11 is prevented.

Upon starting of the engine, the following situation arises: the engine rotational speeds during the engine starting process are very low, approximately 100 rpm, and the rotational speeds of the high-pressure pump 1 and of the predelivery pump 2 are also correspondingly low. At such low rotational speeds, the predelivery pump 2 exhibits very low levels of delivery efficiency owing to the clearances in the delivery toothing. In the event of starting, the metering unit 10 is fully open in order to realize a maximum delivery flow rate of the high-pressure pump 1 for the build-up of pressure in the high-pressure system. In said state, a major part of the very low delivery flow rate of the predelivery pump 2 is now conducted off directly via the zero-delivery throttle 14 back into the unpressurized return line 15, and is thus not made available for the build-up of pressure in the high-pressure system. There is thus a conflict of aims with regard to the realization of a zero-delivery characteristic on the one hand and the starting capability on the other hand. Under unfavorable circumstances (for example low starting rotational speeds owing to low battery voltages, further reduced efficiencies of the predelivery pump owing to high temperatures, low ambient pressures owing to high altitudes, etc.), said conflict of aims is intensified yet further such that they cannot be resolved without further measures, that is to say either the starting of the engine or the zero-delivery characteristic is not possible.

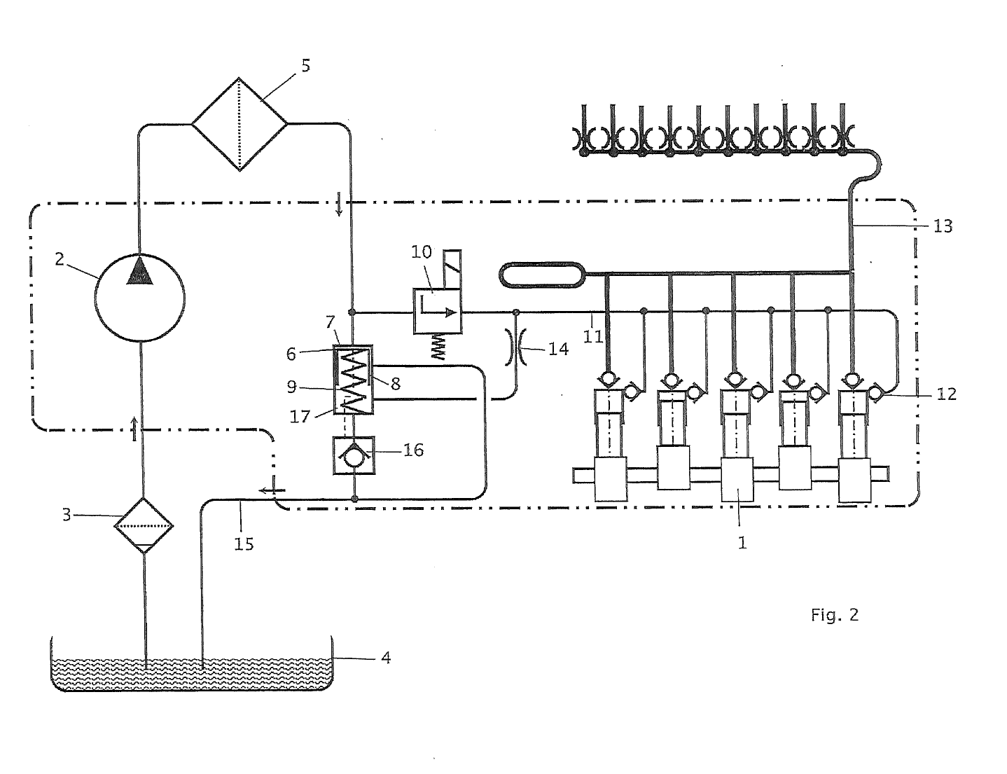

In the embodiment according to the disclosure as per FIG. 2, there is now additionally provided a check valve 16 which determines the flow through the zero-delivery line or the zero-delivery throttle 14. The check valve 16 is in this case arranged below the overflow valve 6 and is opened mechanically by the movement of the valve piston 7 of the overflow valve 6. The valve closing member of the check valve 16 is mechanically coupled to the valve piston 7 for this purpose. The flow passing through the zero-delivery throttle 14 is introduced into the spring chamber 17 of the overflow valve. The outlet for the introduced flow in the direction of the unpressurized return line 15 is opened and closed by means of the check valve 16 that is connected to the spring chamber 17. In the event of starting, the predelivery pressures are lower than would be required for a movement of the valve piston 7. At the same time, owing to the mechanical coupling of the valve piston 7 to the check valve 16, the check valve 16 is closed and thus the flow through the zero-delivery throttle 14 is blocked. Above idle-operation rotational speeds of the engine, owing to the higher predelivery pressures, a movement of the valve piston 7 of the overflow valve 6 takes place, such that the check valve 16 is also opened and thus the flow through the zero-delivery throttle 14 is permitted.

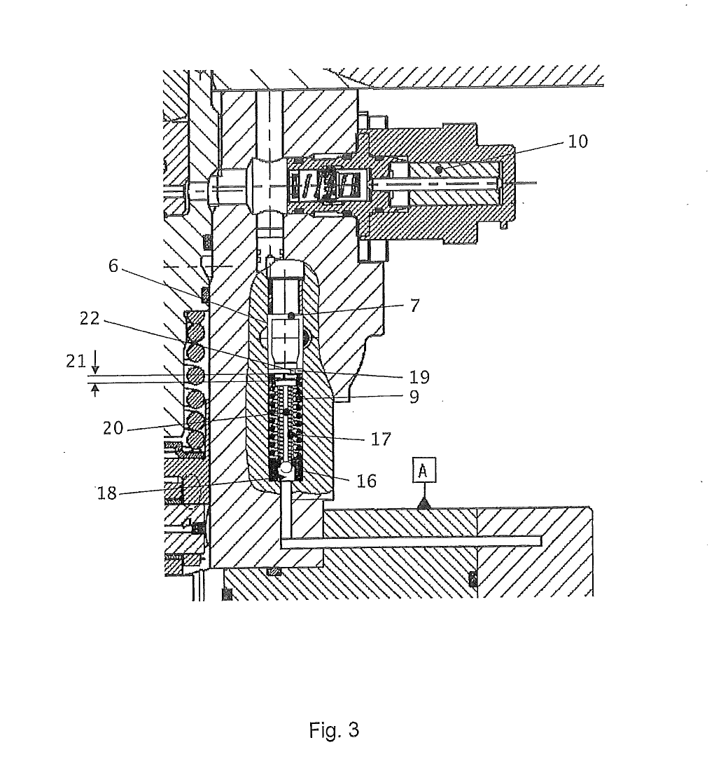

FIG. 3 shows an exemplary design embodiment of the overflow valve 6 together with check valve 16, in which the check valve 16 is located in the bore below the overflow valve 6. The spring 17 of the check valve 16 can be arranged in a space-saving manner within the spring 9 of the overflow valve 6, or alternatively on the opposite outlet side 18. Between the valve piston 7 and the spring 9 there is inserted a plate 19 which, after an idle stroke 21, opens the valve closing member of the check valve 16 via a rod 20. Said plate 19 is formed with a bore 22 such that the fuel in the valve piston 7 can flow in and out freely.

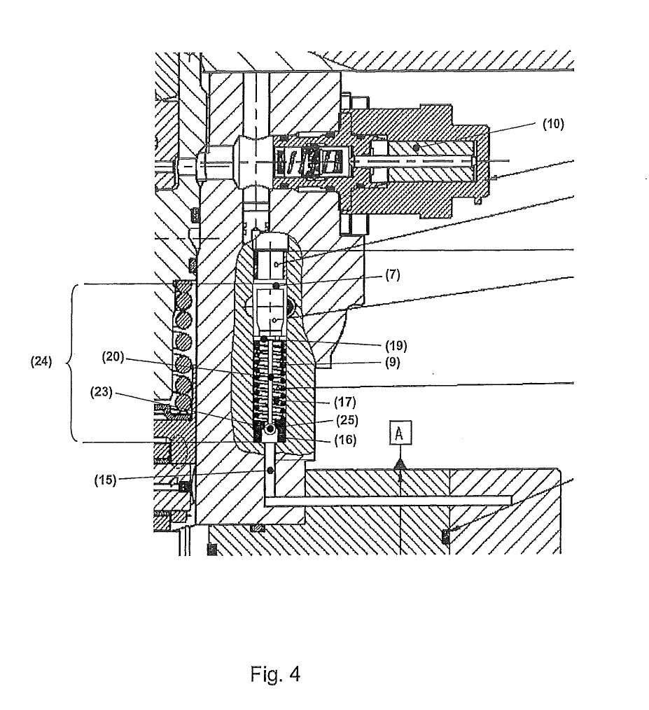

In the modified embodiment as per FIG. 4, the spring 9 of the overflow valve 6 is, by contrast to the situation in FIG. 3, also used for closing the check valve 16: In this design, the valve closing member 23 of the check valve 16 is connected via a rod 20 to a plate 19 which is arranged between the valve piston 7 and the spring 9. In this way, the overflow valve 6 and the check valve 16 are combined to form a unit with only a single spring 24. In order that said unit is fixed in the pump housing in the unpressurized state, an O-ring 25 is arranged in the check valve 16, which O-ring also ensures the leak-tightness between the spring chamber 17 and the unpressurized return line 15.

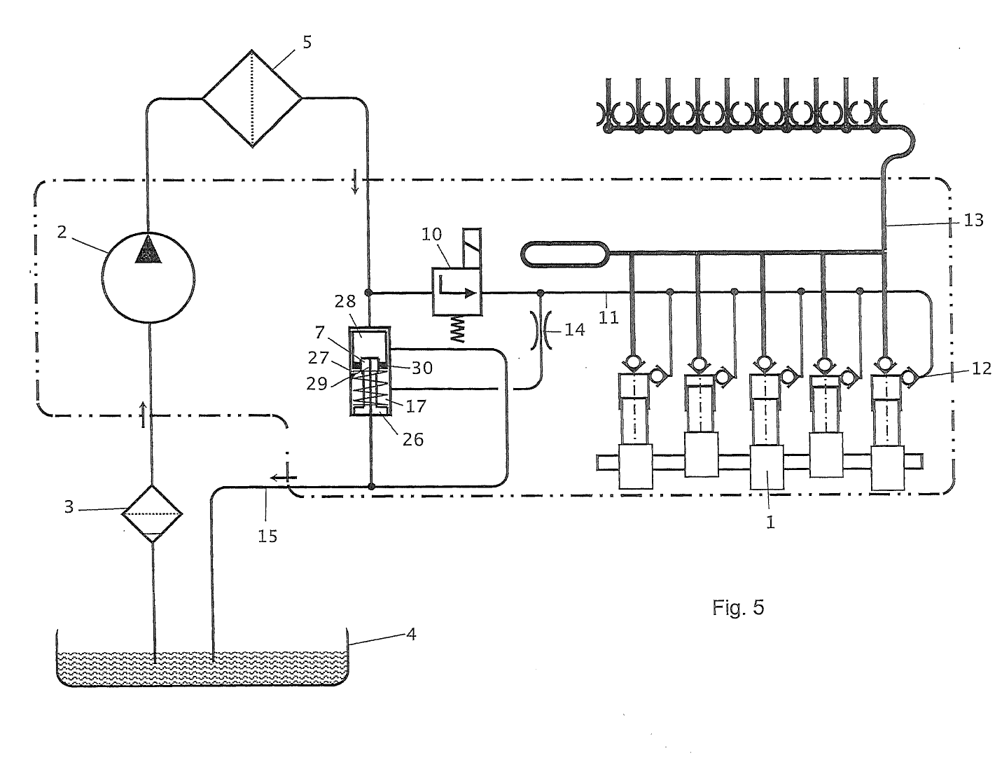

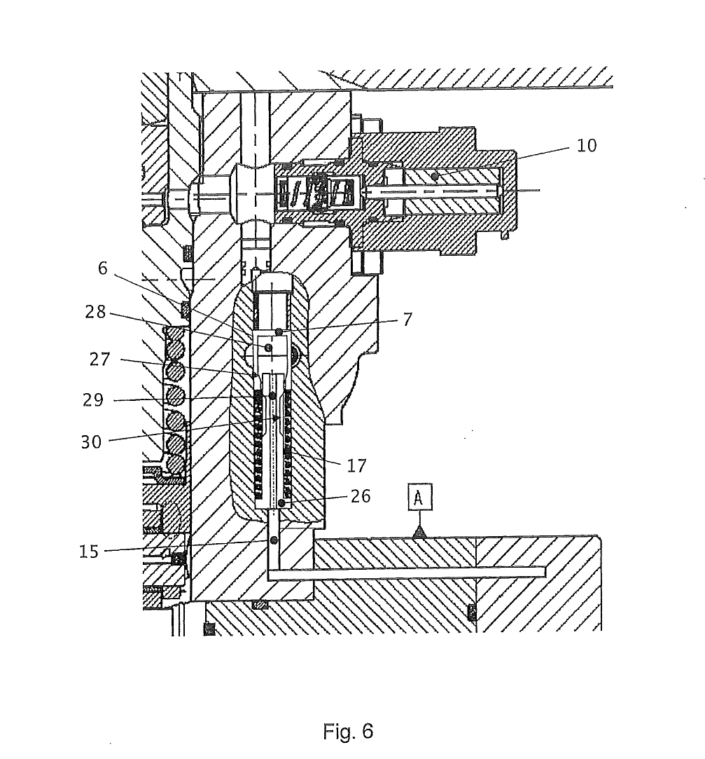

In the embodiment as per FIGS. 5 and 6, the flow through the zero-delivery throttle 14 is controlled by means of a slide valve. By means of an additional insert part 26 in the spring chamber 17 of the overflow valve 6, a slide valve seat 27 composed of the valve piston 7 and the insert part 26 is realized. The zero-delivery flow is introduced into the spring chamber 17, and the flow is then conducted via the slide valve seat into the piston interior 28 and back into the unpressurized outlet 15 via a bore 29 in the insert part 26. The insert part 26 is formed with longitudinal grooves 30 in the discharge region, such that the valve piston 7 is guided cleanly. In the starting situation, the valve piston 7 is not deflected, and accordingly, the slide valve seat 27 is closed and the flow through the zero-delivery throttle 14 is blocked. During normal operation, the valve piston 7 is displaced and the throughflow via the zero-delivery throttle 14 into the unpressurized return line 15 is permitted.

What is claimed is:

1. A low-pressure circuit for a fuel injection system of an internal combustion engine, comprising:
a predelivery pump configured (i) to draw fuel out of a fuel tank, and (ii) to supply the fuel to a low-pressure region of a high-pressure pump via a fuel line;
a metering unit located in the low-pressure region of the high-pressure pump and configured to regulate flow rate;
a zero-delivery line including a zero-delivery throttle, the zero-delivery line being configured to branch off downstream of the metering unit;
an overflow line including an overflow valve, the overflow line being configured to branch off upstream of the metering unit; and
a shut off element located in the zero-delivery line, the shut off element configured to be switched between an open state and a closed state, for the selective opening or blocking of the zero-delivery line.

2. The low-pressure circuit according to claim 1, wherein the shut-off element is located downstream of the zero-delivery throttle.

3. The low-pressure circuit according to claim 1, further comprising:
a control device configured to control the state of the shut-off element as a function of a position of a first valve closing member of the overflow valve.

4. The low-pressure circuit according to claim 3, wherein the control device is configured to open the shut-off element when the overflow valve is opened.

5. The low-pressure circuit according to claim 3, wherein:
the shut-off element includes a shut-off valve having a second valve closing member, and
movement of the second valve closing member is coupled to movement of the first valve closing member, in such a way that the shut-off element is opened when the overflow valve is opened.

6. The low-pressure circuit according to claim 3, wherein the first valve closing member is spring-loaded in a closing direction.

7. The low-pressure circuit according to claim 5, wherein movement of the second valve closing member is coupled to movement of the first valve closing member only after an idle stroke of the first valve closing member has been passed through.

8. The low-pressure circuit according to claim 1, wherein the overflow valve includes a slide valve including a valve closing member formed by a displaceable piston.

9. The low-pressure circuit according to claim 1, wherein the shut-off element includes a check valve.

10. The low-pressure circuit according to claim 1, wherein the shut-off element includes a slide valve.

11. The low-pressure circuit according to claim 1, wherein:
the zero-delivery line issues into a spring chamber of the overflow valve, and
the shut-off element is connected to the spring chamber.

12. The low-pressure circuit according to claim 11, wherein:
the spring chamber is connectable to a piston chamber via a slide valve seat, and
the piston chamber is connected to the fuel return line via a bore formed in an insert part, the bore being configured to extend through the spring chamber.
